(19) United States
(12) Patent Application Publication
(10) Pub. No.: US 2015/0187220 A1
(43) Pub. Date: Jul. 2, 2015

(54) REAL-TIME REWARDS AND MONITORING SYSTEM AND METHOD FOR CHILDREN

(71) Applicant: Mikeshkumar Ishwarbhai Patel, San Leandro, CA (US)

(72) Inventor: Mikeshkumar Ishwarbhai Patel, San Leandro, CA (US)

(21) Appl. No.: 14/141,087

(22) Filed: Dec. 26, 2013

(51) Int. Cl. G09B 5/00; G09B 19/00

(52) U.S. Cl. CPC G09B 5/00; G09B 19/00

(57) ABSTRACT

A system for monitoring in real-time a student's progress and achievements allows parents to set criteria and provide rewards to the student. Teachers, coaches, leaders, relatives and other adults log onto the system and provide input on how well the student is doing. For example, a teacher updates the student's account with grades. The ratings are completed on-line using a device. Once the student achieves a goal, then the student receives a reward using a device coupled to a server within the system.

### FIELD OF THE INVENTION

The present invention relates to the real-time reward and monitoring system for children and devices attached to a network. More particularly, the present invention relates to a system to monitor, educate, rewards and provide content to children as controlled on a smart device.

### DISCUSSION OF THE RELATED ART

Parents struggle to understand how their children are doing at a given period of time. At school, parents may receive progress reports every so often about their grades, but a letter or numerical grade may not provide a good report of effort and attitude. Further, these reports come out every couple weeks, and represent past behavior. Parents cannot really reward or address past behavior except to give or take away privileges from their children. The children have no real motivation to try harder as the results come from past behavior.

This issue goes beyond schoolwork into other areas of a child's life. Parents want their children to work hard at endeavors such as sports, art, music, scouts, bands, science projects and the like. Feedback may come at the end of the season, or by winning a championship. Many times, parents are not aware of the effort put in by the child and whether the child is meeting goals and requirements. Further, coaches and other leaders may not have any real manner to inform parents that their child is not meeting expectations except through emails or phone calls. Many times, people are too busy to do this, and no feedback is provided.

Moreover, a child is usually rewarded by gifts or rewards at the end of a year or season. Most children cannot think that far ahead. They get discouraged because any possible reward for their efforts in far in the future. Rewards are not provided to the child in timely manner, or in a time frame the child can understand.

### SUMMARY OF THE INVENTION

A computer-implemented method for rewarding behavior by a child is disclosed. The method includes receiving at least one input from a third party via a network connection to a server. The at least one input corresponds to an activity of the child. The method also includes determining whether the at least one input meet criteria set by a parent. The method also includes determining whether the criteria meet a goal. The method also includes enabling a reward associated with the goal. The reward is provided on a device connected to the network.

A computer-implemented method for executing a reward system for a parent-child relationship also is disclosed. The method includes receiving at least one input from a third party about an activity of a child. The method also includes determining a reward by a recommendation engine for use on a device by the child based on the at least one input. The method also includes enabling the reward on the device by the child.

A reward system also is disclosed. The reward system includes a server configured to receive at least one input by a third party about a child. The reward system also includes a recommendation engine controlled by a parent of the child, and configured to receive the at least one input and determine whether a reward is available to the child. The reward system also includes a device configured to enable the reward to the child based on information received from the recommendation engine.

Incentive for providing comments and feedback for the disclosed system and methods lies in the fact that users will select teachers, coaches, and the like that participate in the disclosed system as opposed to those that do not. Thus, tutors, schools, coaches, and the like may market themselves as friendly to the disclosed approaches and willing to help the child improve.

Tracking of the use of rewards and incentives may occur in a centralized environment such that the parent does not have to manually determine when the rewards or incentives have been used. The system will determine this, so that the child does not negotiate or argue about additional privileges, and the like. For example, a parent says that the time is complete for playing a game, and the child complains that he/she needs more time, that the reward is not fair. The disclosed embodiments remove this stress.

The disclosed embodiments may incorporate facial recognition, facial or retinal scans, fingerprint analysis, or other means to identify the child, or participant in the system. If the child plays outside, a timer or signal may be sent to a smart phone or device to alert the parent that the play time is complete. Same thing for going to the mall, or social events that do not involve the direct use of a device. The child's smart device may be alerted that the time is complete and he/she is to meet their parent.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a rewards and monitoring system for parents and children according to the disclosed embodiments.

FIG. 2A illustrates a device for use in the system according to the disclosed embodiments.

FIG. 2B illustrates a block diagram of a recommendation engine according to the disclosed embodiments.

FIG. 3 illustrates a flowchart for implementing and using a rewards and monitoring system for parents and children according to the disclosed embodiments.

FIG. 4 illustrates a flowchart for providing third part materials to the student using the system according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

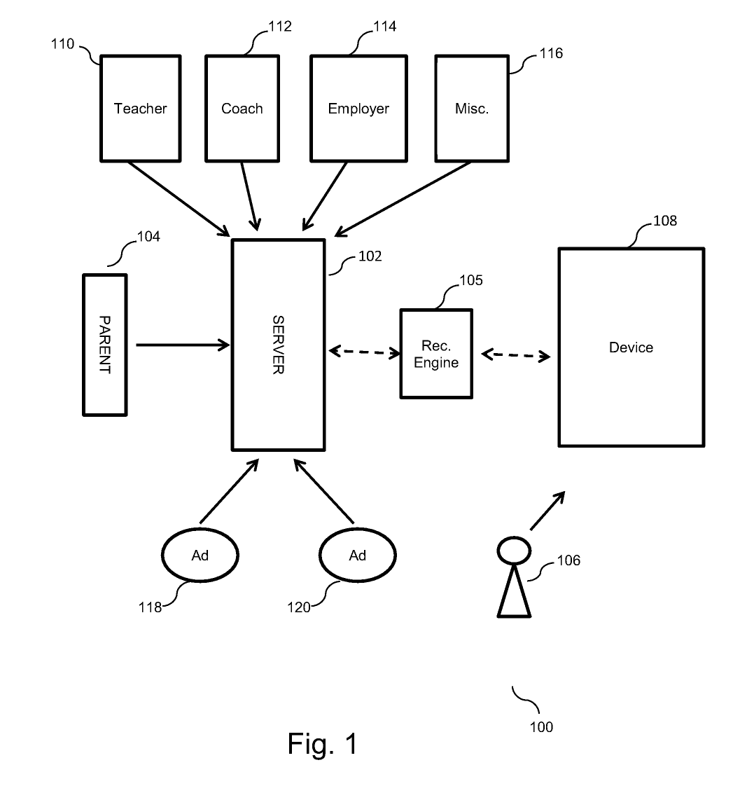

FIG. 1 depicts a rewards and monitoring system 100 according to the disclosed embodiments. System 100 interacts with parent 104, central server 102, and device 108 to deliver content, programming, games, and the like to child 106. System 100 may interact with any number of children, and may include several devices. A single child and a single device is shown and disclosed for simplicity.

Central server 102 is accessible by a computer used by parent 104 and connected to device 108 via an on-line network. Server 102 includes a processor, memory and other associated components to store data and execute instructions to control device 108. Server 102 also is accessible by the other parties in system 100. This feature is important so that the different parties shown in FIG. 1 do not have to interact directly with each other. Alternatively, a plurality of servers may be connected to provide the functionality disclosed below. Server 102 also may be connected to the different components of system 100 through a cloud network.

Parent 104 may represent a computer or number of computers used by a parent to log onto system 100 and access server 102. Although the term parent is used in this specification, this term may refer to a guardian, sibling, or anyone having a legal responsible status in caring for a child. Further, the term “child” may refer to any party being taken care of by another, such as special needs adults, one under a doctor's care and unable to make decisions, and the like. Further, the relationship is also extended to any scenario in which one person has some level of responsibility, care or supervisory control over another, such as coach-player, employer-employee, caregiver-recipient, and teacher-student. An individual may also choose to use the invention for self-administering or managing their goals and objectives. Rather than having a second individual, such as a parent or employer monitor their progress, using this invention they may choose to self-administer various aspects of their life, such as academic, physical, professional, or personal development. For example, an individual may use it follow a workout routine and reward themselves if they are successful in achieving their workout milestones or use it for achieving a certain skill level or studying for an examination.

Multiple parents also may be involved, especially for extended families. Preferably, one parent account is formed so that a plurality of people are not controlling the rewards and monitoring of content to child 106, but more than one parent can use the account. Using the disclosed embodiments, parent 104 may see how child 106 in a number of areas, most preferably academic. Parent 104 may view the performance of child 106 in real-time without waiting for report cards.

This feature is accomplished by receiving input and evaluations from third parties. Third parties may include teachers 110, coaches 112, employers 114 and miscellaneous actors 116. There is no limit as to whom or what the third parties can be. The third parties log onto system 100 to access server 102 to give rewards for child 106. Server 102 compiles and stores the rewards input. Although third parties are shown as boxes, it should be understood that each third party uses a computer or device to get on-line to access system 100 and server 102. Where applicable, an application is used to receive input from the third parties.

For example, child 106 does an activity, receives a score, achieves a goal, earns a badge and the like. For teacher 110, child 106 may receive a high grade or complete a project in a class. Teacher 110 indicates this accomplishment on server 102. Other examples include finishing assigned homework, good attitude in class, participation in class, and the like. Teacher 110 may get on-line and do this every day, much like a grade book. Server 102 compiles this information from a plurality of teachers.

Coach 112 may represent those individuals also having a guidance or leadership relationship with child 106. Sport coaches, tutors, music teachers, theater coaches and the like may set goals and evaluate child 106 based on these goals. Coach 112 can provide reward data for a job well done during a contest, met goals, attitude and the like. Coach 112 also may get on-line to provide the rewards.

Employer 114 may refer to parties having business relationship with child 106. Many high school students work part-time jobs and system 100 allows these people to provide rewards for child 106 beyond just a paycheck. Employer 114 also may refer to people running a volunteer organization, a service organization, church or faith-based organization, and the like. Child 106 may not receive a paycheck but does perform tasks for these people. Employer 114 also may refer to neighbors or people that child 106 does odd jobs or chores for.

Miscellaneous parties 116 may refer to anyone else that parent 104 desires to provide rewards for child 106. Scout leaders, other family members, clubs, and the like. Preferably, miscellaneous parties 116 should establish criteria so that child 106 can meet these and this fact noted on server 102.

The third parties give rewards pertaining to child 106. Preferably, the rewards are given for off-line activity. On-line activity also may be included, but this can be monitored in real-time by system 100, and would not necessarily need to connect between the third parties and server 102. Child 106 may learn skills and perform tasks on-line. Child 106 also may learn programming skills and have these compiled by server 102. Child 106 may work on physical accomplishments, such as running a certain distance every day, or taking a number of foul shots. System 100 may receive this information by entry by child 106, or any of the other parties disclosed above.

For each input, parent 104 can design criteria (done/not done, pass/fail, performance goals, etc.) for child 106 to meet in relation to a third party. Parent 104 also may create a measuring metric for grades, goals and accomplishments. The third party can provide a number or rating instead of a pass/fail type evaluation. The third party, or provider, may access server 102 via a website or application. Once all the input is received, parent 104 can reward child 106.

Rewards may be provided to child 106 via device 108 using recommendation engine 105. Recommendation engine 105 and device 108 are disclosed in greater detail below. Device 108, preferably, is a smart device, such as a smart television, smart phone, game console, gaming system, computer, tablet and the like. The reward may consist of times for use of device 108, content on device 108, shopping, social media, texting and the like. Child 106 should be able to see their goal and how much of it is left.

Parent 104 sets the rewards and tie them to the goals met by the information provided to server 102. Server 102 provides this information to recommendation engine 105. Recommendation engine 105 tracks the goal levels and sets the rewards. As child 106 uses device 104, then recommendation engine 105 may decrease the amount of rewards available to child 106. Recommendation engine 105 may track the use of the rewards over multiple devices 108.

Recommendation engine 105 is shown as a separate entity but it may reside on server 102 or device 108. Alternatively, recommendation engine 105 may reside on a separate computer or device, and run as an application to track activity and accomplishments, as well as rewards.

Parent 104 may be able to log onto server 102 to access recommendation engine 105 in order to determine what levels of rewards and goals are available for child 106. They may log onto system 100 daily and in real-time. Parent 104 also may set server 102 or recommendation engine 105 to send reminders/prompts to providers so as to get as much evaluation/feedback information for rewards as possible.

Advertiser 118 and retailer 120 represent one or more advertisers and retailers. These components are important as parent 104 may allow these entities to provide content to child 106. Advertiser 118 may provide advertising for products or services geared towards child 106. Retailer 120 may provide the same information, but from a specific retailer as part of a buying program, loyalty program and the like. Parent 104 may place controls and limits on the content provided by these entities.

Advertiser 118 and retailer 120 also may pay for access to system 100. If parent 104 allows this service in return for not paying a fee, then advertisers and retailers may market their products and services. For example, reaching a certain level may result in a coupon or discounts to child 106. A gaming store may provide a 20% coupon upon reaching a grade point average for games. Such incentives may mean more to child 106 than normal rewards that come in at the end of the school year or season.

Thus, parent 104 may tie in a large number of incentives for child 106. Conventional on-line programs only market a finite number of services and products. System 100 may tie in any number of companies and services. Recommendation engine 105 may process these to provide the appropriate or proper advertising content to device 108, and, inevitably, to child 106.

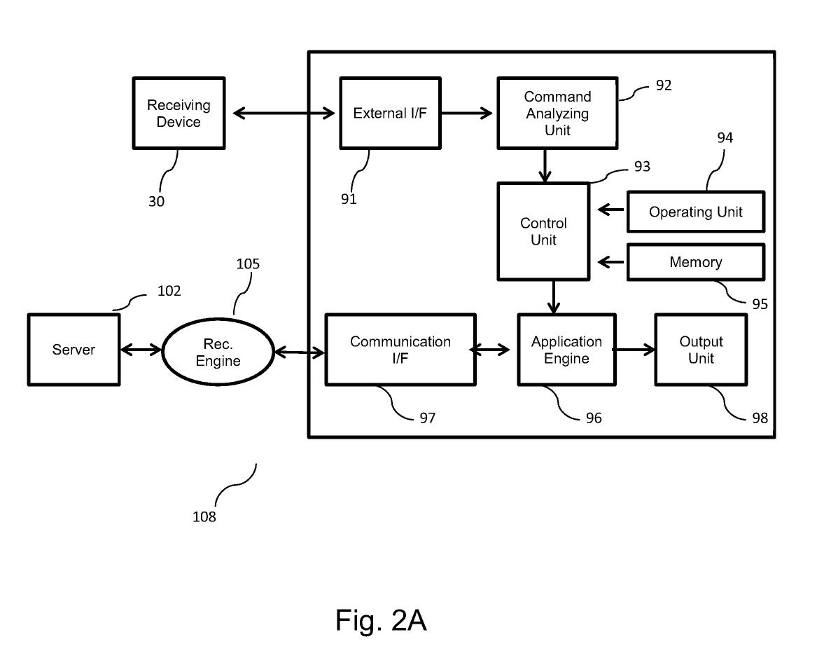

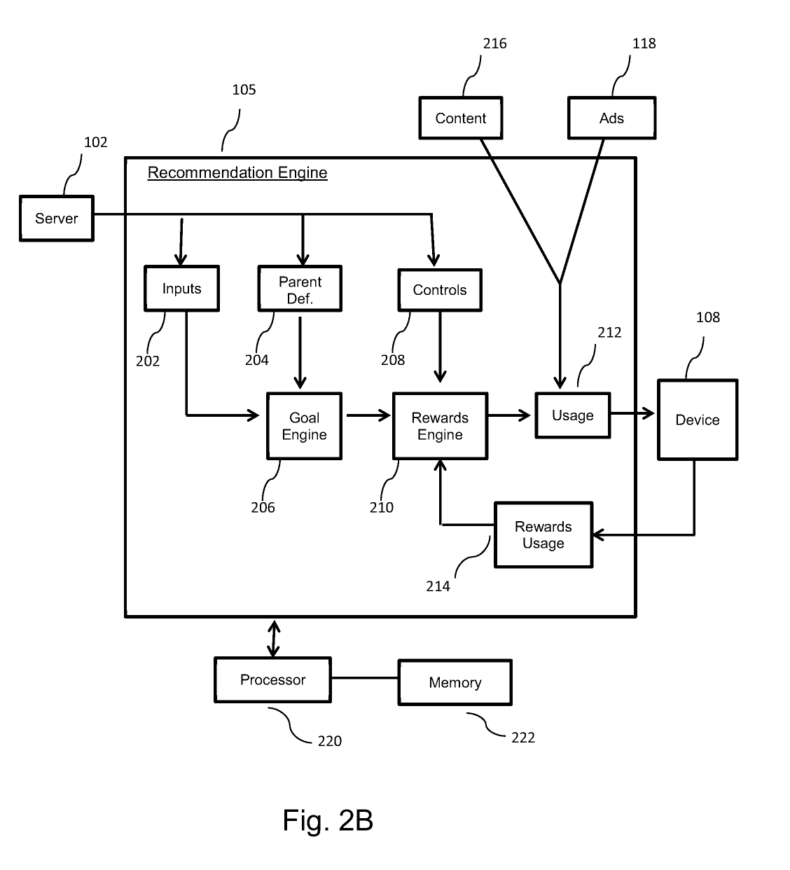

FIG. 2A depicts a block diagram of device 108 for use in the system 100 according to the disclosed embodiments. FIG. 2A is an example of an external smart device 108 connected to recommendation engine 105 and server 102 within system 100. Preferably, smart device 108 is a smart television that allows child 106 to watch programming and content. It should be noted that FIG. 2A shows only the components related to execution of the program or application for the rewards and monitoring system, and does not show the components not related to execution of the disclosed embodiments.

Smart device 108 includes an external I/F 91, a command analyzing unit 92, a control unit 93, an operating unit 94, a memory 95, an application engine 96, a communication I/F 97 and an output unit 98. Application engine 96 may be tied to recommendation engine 105. Parent 104, or any user, may download application engine 96 to smart device 108, while recommendation engine 105 is loaded onto a computer or device used by parent 104. If recommendation engine 105 is loaded onto smart device 108, then it may be combined with application engine 96.

Recommendation engine 105 and application engine 96 may exchange data to provide rewards and account for rewards used by child 106. For example, child 106 uses smart device 108, application 96 may request whether child 106 is allowed to use the device to recommendation engine 105. Recommendation engine 105 may respond with the amount of time for use. Once child 106 is done using smart device 108, application engine 96 may update this information to recommendation engine 105.

External I/F 91 has a wireless or wired connection with receiving device 30, and outputs the command supplied from receiving device 30 to command analyzing unit 92. Command analyzing unit 92 analyzes the command from receiving device 30, and outputs the analysis result to control unit 93.

Control unit 93 controls the entire external device 40 by executing a control program as a platform recorded in memory 65. Based on the analysis result supplied from command analyzing unit 92, control unit 93 also controls the acquirement of the application, the start of the application, firing of an event, a suspension of the application, the end of the application and the like.

The control program to be executed by control unit 93 is recorded in memory 95. Operating unit 94 receives various kinds of operations from a user, such as child 106, and notifies control unit 93 of the operating signals corresponding to these operations.

Under the control of control unit 93, application engine 96 acquires the application from server 102 via communication I/F 97, and executes the application. The video signal and the audio signal of the information related to the content being received by receiving device 30 are acquires as a result of the execution, and are output to output unit 98. Under control of application engine 96, communication I/F 97 connects to server 102 via internet 3.

Output unit 98 displays the video image corresponding to the video signal input from application engine 96, and outputs the sound corresponding to the audio signal. Application engine 96 also may enact the limits placed on device 108 by the disclosed embodiments. Parent 104 also may override these limits by inputting a code or password so that the parents are not subject to any limits placed on child 106.

FIG. 2B illustrates a block diagram of a recommendation engine 105 according to the disclosed embodiments. As disclosed above, recommendation engine 105 may interact between a central server 102 and at least one device 108 to enable to determination of rewards based on received input. Recommendation engine 105 also may compile the inputs while determining whether goals have been met.

It should be understood that recommendation engine 105 runs in a computing environment. As disclosed above, recommendation engine 105 may reside on server 102, device 108 or as a separate entity. Although recommendation engine 105 is shown as a single entity, it should be understood that recommendation engine 105 refers to a collection of functionalities that can be implemented as software, hardware, firmware or any combination of the three.

Where a recommendation engine 105 is implemented as software, it can be implemented as a standalone program, but can also be implemented in other ways, for example as part of a larger program, as a plurality of separate programs, or as one or more statically or dynamically linked libraries. In some embodiments, recommendation engine 105 is implemented as a component of a software program which can run on a processor 220 using a memory 222. In other embodiments, the functionalities performed by recommendation engine 105 are distributed between multiple processors and memories, as well as server 102 and device 108.

Memory 222 may store instructions executed on processor 220 to provide the functionality embodied by the components of recommendation engine 105. Multiple memory locations may be used to store these instructions.

Referring to FIG. 2B, server 102 provides all the information compiled over system 100 from the different entities shown in FIG. 1. This information includes inputs 202. Recommendation engine 105 receives these inputs, which includes feedback, scores, ratings and the like from teachers, coaches, and the like for child 106. Inputs 202 preferably are represented in a numerical format. Recommendation engine 105 also may weigh inputs 202 so that different inputs count more towards the rewards than others. For example, grades may be weighted higher than physical accomplishments.

The provided information also includes parent defined metrics 204. Parent 104 may define levels or achievements for which child 106 receive rewards. Recommendation engine 105 sets levels for accomplishments, reflected in goals engine 206, using parent defined metrics 204.

Inputs 202 and metrics 204 are provided to goals engine 206. Goals engine 206 compares the values associated with inputs 202 with metrics 204 to determine whether the activities and accomplishments of child 206 have met any goals to receive rewards. Goals engine 206 may use an algorithm to determine whether goals have been met. Goals engine 206 then provides this information to rewards engine 210.

Rewards engine 210 determines what rewards are available for redeeming by child 106. Controls 208 may refer to parental controls or limits defined by parent 104. Controls 208 also may refer to control on the content that may be provided to device 108. Some content may not be appropriate and this also may limit what is provided from other parties through usage engine 212. Rewards engine 210 also lists the rewards that may be provided, such as time on device 102, content 216, and the like.

Usage engine 212 receives the instructions from rewards engine 210 and then routes content 216 and advertisements 118 to device 108. Usage engine 212 does not sit between the content and advertisements, but, instead, sends commands to device 108, to allow this information to be shown. For a computer or game console, usage engine 212 may allow usage of the machine by child 106. Device 108 also provides rewards usage 214 back to rewards engine 210 so that this entity can track how much rewards are available for use, and feed this back to usage engine 212.

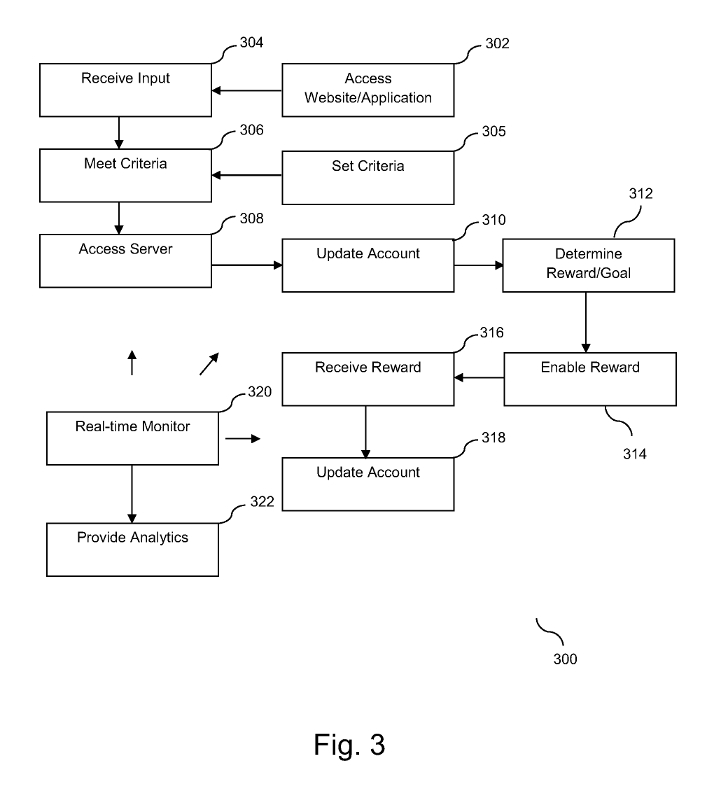

FIG. 3 depicts a flowchart 300 for implementing and using a rewards and monitoring system for parents and children according to the disclosed embodiments. Step 302 executes by accessing the website, portal or application for the disclosed embodiments. A user would load the website onto a browser on their device. The user could log onto the system for the rewards and monitoring system. Preferably, a secure log-on is used. The user would access a dedicated account for a specific child.

Step 305 executes by receiving input from a teacher, coach, parent, and the like for the student. The input may be a grade, ratings, yes/no meet criteria, and the like, as disclosed above. Step 304 executes by setting criteria for the student to meet. The parent may set levels that trigger rewards when the student meets the criteria. The criteria may be stored in a memory or server on the system, such as server 102. The criteria may be accessed by the disclosed process while in use.

Step 306 executes determining whether the inputs or scores for the student meets the criteria set by the parent. Step 308 executes by accessing server 102 to update the account and store the new results generated by the input. Step 310 executes by updating the account with the new results. Step 312 executes by determining whether a reward or goal has been met based on the inputs and scores provided by the teachers, coaches, and the like for the student. Moreover, computer tracking of the student using tests and on-line courses may be used to monitor the student's efforts.

Step 314 executes by enabling a reward if the student has met the criteria set above. The system may send a message or signal to a device to unlock the reward. Thus, step 316 executes by receiving the reward by the student. As disclosed above, the device (game console, tablet, phone, and the like) may receive a command from the system to enable the reward. Preferably, a time limit is set for the device for the reward. The disclosed embodiments track use of the reward and lock the device once the limits have been met. Step 318 executes by updating the account for the student with the rewards used and earned.

Step 320 executes by monitoring the system or account for the student in real-time. Step 322 executes by providing analytics on the student's progress. Thus, using these steps, a parent or guardian may see how the student is doing at any time. The parent or guardian does not have to wait for progress reports, tests, end of the season, and the like to see how the student is performing. Analytics may show the student as compared to other students within the system, school, team, demographics and the like.

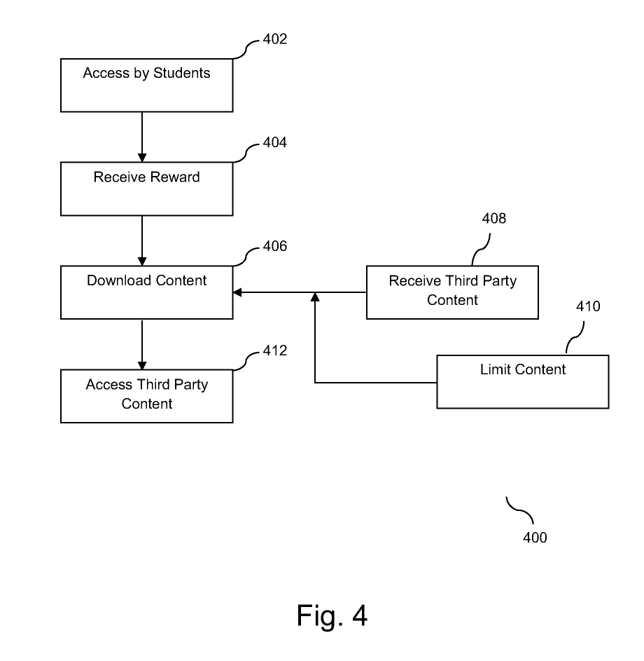

FIG. 4 depicts a flowchart 400 for providing third part materials to the student using the system according to the disclosed embodiments. Step 402 executes by accessing the system by the student. Preferably, the student is unlocking a reward earned by achievements. Step 404 executes by receiving the reward. In this embodiment, the student is receiving content as the reward, such as a movie, program, game, music, and the like. Step 406 executes by downloading the content to a device used by the student.

Step 408 executes by receiving third party content along with the downloaded content. This third party content may be advertisements or offers targeted to the student based on the goals and achievements. For example, an advertisement for science project kits may be targeted to a student having high grades or marks in science. Sporting goods made available to those students achieving athletic goals.

Step 410 executes by limiting the content by the parent. The parent may not want adult or older teenager content made available for a younger child. Rated “M” games are not made available to children younger than 12 years old. The parent does not have to worry about inappropriate content being provided to the student.

Step 412 executes by accessing third party content by the student. If the content interests the student while receiving the content from the reward, then he/she may access it by clicking or selecting the advertisements, for example. Doing so also may result in a financial compensation to the advertiser. Moreover, the revenue raised by the advertisements may offset the costs of using the system. Thus, parents and students may enroll in the system for free if allowing the third party content onto the rewards.

The disclosed embodiments also include a process of customizing or modifying the daily doses of medications that allows the storing of default preferences for dosing. The default preferences take into account factors impacting medication efficacy, such drug interactions, time of day, food intake for best efficiency, and the like.

It should be appreciated that the disclosed embodiments could be offered as a business method on a subscription or fee basis. For example, system 100 including a transaction process could be created, maintained or deployed by a service provider that offers the functions described herein for customers. A service provider could offer to deploy or provide the ability to process content to generate a website using the disclosed processes.

In addition to being implemented as system and processes, the disclosed embodiments may be provided as a program product stored on a computer-readable medium, which, when executed, enables the system to monitor a student's progress. To this extent, the computer-readable medium may include program code, which implements the processes and system disclosed herein. The term “computer-readable medium” includes one or more of any type of physical embodiment of the program code implementing the steps to execute the disclosed processes. In particular, the computer-readable medium can comprise program code embodied on one or more portable storage articles of manufacture, such as a compact disk, a DVD, a Blu-ray disk, a magnetic disk, a tape and the like, on one or more data storage portions of a computing device, such as a memory.

As used herein, the terms “program code” and “computer program code” are synonymous and refer to any expression, in any language, code or notation, of a set of instructions that cause a computing device having an information processing capability to perform a particular function either directly or after any combination of the following: (a) conversion to another language, code or notation; (b) reproduction in a different material form; or (c) decompression. To this extent, program code can be embodied as one or more types of program products, such as an application/software program, component software/library of functions, an operating system, a basic input/output system/driver for a particular computing or input/output device and the like. Terms such as “component” and “system” are synonymous as used herein and represent any combination of hardware or software capable of performing some function(s).

The block diagrams in the Figures illustrate the architecture, functionality and operation of possible implementations of system and flowcharts, plus possible computer program products. Each block in the block diagrams may represent a module, segment, or portion of code, which comprises one or more executable instructions for implementing the specified logical function(s). The functions noted in the blocks may occur out of order noted in the figures. For example, two blocks shown in succession may be executed substantially concurrently, or the blocks may sometimes be executed in the reverse order, depending upon the functionality involved. Each block of the block diagrams can be implemented by special purpose hardware-based systems that perform the specified functions or acts, or combinations of special purpose hardware and computer instructions.

It will be apparent to those skilled in the art that various modifications and variations may be made in the disclosed embodiments of the disclosed methods and systems without departing from the spirit or scope of the invention. Thus, it is intended that the present invention covers the modifications and variations of the embodiments disclosed above provided that the modifications and variations come within the scope of any claims and their equivalents.

What is claimed is:

1. A computer-implemented method for rewarding behavior by a child, the method comprising:
receiving at least one input from a third party via a network connection to a server, wherein the at least one input corresponds to an activity of the child;
determining whether the at least one input meet criteria set by a parent;
determining whether the criteria meet a goal; and
enabling a reward associated with the goal, wherein the reward is provided on a device connected to the network.

2. The computer-implemented method of claim 1, wherein receiving input includes receiving a grade or a rating from the third party.

3. The computer-implemented method of claim 2, wherein the grade or the rating pertains to the goal.

4. The computer-implemented method of claim 1, further comprising accessing the server via a website or an application.

5. The computer-implemented method of claim 4, wherein the website or the application is separate from the server or the device.

6. The computer-implemented method of claim 1, further comprising providing analytics on the activity of the child.

7. The computer-implemented method of claim 1, further comprising setting a control on the reward.

8. The computer-implemented method of claim 1, further comprising tracking a usage of the reward on the device.

9. The computer-implemented method of claim 1, wherein the device comprises a smart device.

10. A computer-implemented method for executing a reward system for a parent-child relationship, the method comprising:
receiving at least one input from a third party about an activity of a child;
determining a reward by a recommendation engine for use on a device by the child based on the at least one input; and
enabling the reward on the device by the child.

11. The computer-implemented method of claim 10, further comprising controlling use of the reward by a parent.

12. The computer-implemented method of claim 10, further comprising limiting the reward based on a control.

13. The computer-implemented method of claim 10, further comprising downloading the recommendation engine to the device.

14. The computer-implemented method of claim 10, further comprising providing an advertisement on the device based on the reward.

15. The computer-implemented method of claim 14, further comprising placing a parental control on the advertisement.

16. A reward system comprising:
a server configured to receive at least one input by a third party about a child;
a recommendation engine controlled by a parent of the child, and configured to receive the at least one input and determine whether a reward is available to the child; and
a device configured to enable the reward to the child based on information received from the recommendation engine.

17. The reward system of claim 16, wherein the third party is a teacher, coach, or instructor of the child.

18. The reward system of claim 16, wherein the device is a smart television, a smart device, a game console or a computer.

19. The reward system of claim 16, wherein the reward comprises content delivered to the device.

20. The reward system of claim 16, further comprising an application engine on the device configured to exchange information with the recommendation engine.
